(19) United States
(12) Patent Application Publication
(10) Pub. No.: US 2019/0084098 A1
(43) Pub. Date: Mar. 21, 2019

(54) CLAMP JIG, STATOR MANUFACTURING APPARATUS, AND STATOR MANUFACTURING METHOD

(71) Applicant: HONDA MOTOR CO., LTD., Tokyo (JP)

(72) Inventors: Tsukasa Yoneyama, Hagagun, Tochigi (JP); Keitaro Momosaki, Hagagun, Tochigi (JP)

(21) Appl. No.: 16/084,828

(22) PCT Filed: Mar. 17, 2017
(86) PCT No.: PCT/JP2017/010995

§ 371 Date: Sep. 13, 2018

(30) Foreign Application Priority Data
Mar. 17, 2016 (JP) 2016-054474

(51) Int. Cl. B23K 37/04; H02K 15/00

(52) U.S. Cl. CPC B23K 37/0443; H02K 3/04; H02K 15/0081

(57) ABSTRACT

A clamp jig includes: a pair of clamp bodies that extend in the radial direction of a stator core and that clamp, from both circumferential sides of the stator core, an end part of an electric conductor that is inserted into and welded to the stator core; and a sandwiched part that is supported so as to be able to rotate with respect to the clamp bodies and that abuts against the end part of the electric conductor when the end part of the electric conductor is clamped between the pair of clamp bodies. The sandwiched part has a plurality of abutting surfaces that can abut the end part of the electric conductor in a direction of rotation of the sandwiched part.

### TECHNICAL FIELD

The present invention relates to a clamp jig clamping an end part of a coil segment inserted in a stator core before welding, a stator manufacturing device, and a method for manufacturing a stator.

### BACKGROUND ART

Conventionally, a motor in which a coil segment is inserted in a stator core is known as a motor mounted in an automobile, reduced in size, and increased in output. A stator of the motor is manufactured by end parts of the coil segment inserted in the stator core being clamped and welded two by two. Various clamp jigs are used for the clamping of the segment end parts (see, for example, Patent Document 1).

Patent Document 1: Japanese Unexamined Patent Application, Publication No. 2014-107876

### DISCLOSURE OF THE INVENTION

### Problems to be Solved by the Invention

When the clamp jig disclosed in Patent Document 1 is used over and over, the clamp jig slides with respect to the segment end part when the clamp jig is opened and closed during clamping of the segment end part by the clamp jig. Accordingly, wear occurs at the part of the clamp jig that clamps the segment end part. In addition, welding heat is transferred to the clamp jig via the segment end part by the segment end part being welded with the segment end part clamped, and then the clamp jig is damaged.

Accordingly, the clamp jig needs to be replaced after used a predetermined number of times. The unit price of the clamp jig is high due to the complex shape thereof. In addition, a stator manufacturing line should be stopped during clamp jig replacement, and thus frequent replacement is undesirable.

An object of the present invention is to provide a clamp jig that can be used for a long period of time, a stator manufacturing device, and a stator manufacturing method that uses the clamp jig or the stator manufacturing device.

### Means for Solving the Problems

In order to achieve the above object, the present invention provides a clamp jig (such as a clamp jig 40 to be described later) including a pair of clamp bodies (such as clamp bodies 41 to be described later) that extends in the radial direction of a stator core (such as a stator core 21 to be described later) and that clamps, from both circumferential sides of the stator core, an end part (such as an end part 31 to be described later) of an electric conductor (such as a segment 30 to be described later) that is inserted into and welded to the stator core, and a sandwiched part (such as a sandwiched part 463 to be described later) that abuts against the end part of the electric conductor when the end part of the electric conductor is clamped between the pair of clamp bodies, in which the sandwiched part has a plurality of abutting surfaces (such as abutting surfaces 464 to be described later) that can respectively abut against the end parts of the electric conductor by the clamp jig rotating.

According to the present invention, abutting against the end part of the electric conductor and clamping of the end part of the electric conductor can be performed by means of another abutting surface of the sandwiched part of the clamp jig in the event of wear of one abutting surface of the sandwiched part supported by the clamp body. Accordingly, the clamp jig can be continuously used without replacement even in the event of wear of one abutting surface of the sandwiched part of the clamp jig, and thus the clamp jig can be used for a long period of time.

In addition, the present invention provides a stator manufacturing device (such as a welding device 10 to be described later) manufacturing a stator by welding an end part (such as an end part 31 to be described later) of an electric conductor (such as a segment 30 to be described later) inserted in a stator core (such as a stator core 21 to be described later), the stator manufacturing device including a pair of clamp jigs (such as clamp jigs 40 to be described later) that extends in the radial direction of the stator core and that clamps, from both circumferential sides of the stator core, an end part of an electric conductor to be welded, moving means for allowing the stator core and the clamp jig to move relative to each other in the axis direction of the stator core, and clamp jig opening and closing means for opening and closing the pair of clamp jigs by moving the pair of clamp jigs, in which the clamp jig includes a clamp body (such as a clamp body 41 to be described later) and a sandwiched part (such as a sandwiched part 463 to be described later) abutting against the end part of the electric conductor when the end part of the electric conductor is clamped between the pair of clamp bodies and the sandwiched part has a plurality of abutting surfaces (such as abutting surfaces 464 to be described later) that can respectively abut against the end parts of the electric conductor by the clamp jig rotating.

According to the present invention, actions and effects similar to those of the invention relating to the clamp jig described above are achieved.

In addition, the present invention provides a method for manufacturing a stator for manufacturing a stator by using the clamp jig described above or the stator manufacturing device described above.

According to the present invention, actions and effects similar to those of the invention relating to the clamp jig described above are achieved.

### Effects of the Invention

According to the present invention, a clamp jig that can be used for a long period of time, a stator manufacturing device, and a stator manufacturing method that uses the clamp jig or the stator manufacturing device can be provided.

### BRIEF DESCRIPTION OF THE DRAWINGS

FIG. 1 is a schematic diagram illustrating how a stator 20 is manufactured by means of a welding device 10 as a stator manufacturing device according to an embodiment of the present invention.

FIG. 2 is a plan view illustrating a clamp jig 40 according to an embodiment of the present invention.

FIG. 3 is a perspective view illustrating the clamp jig 40 according to an embodiment of the present invention.

FIG. 4 is a diagram illustrating how the stator 20 is manufactured by means of the stator manufacturing device 10 according to an embodiment of the present invention. FIG. 4(a) is a plan view illustrating a state where an end part 31 of a segment 30 is yet to be clamped by the clamp jig 40. FIG. 4(b) is a plan view illustrating a state where the segment end part 31 is clamped by the clamp jig 40. FIG. 4(c) is a sectional view taken along line c-c of FIG. 4(a). FIG. 4(d) is a sectional view taken along line d-d of FIG. 4(b). FIG. 4(e) is a sectional view illustrating how the segment end part 31 is welded.

### PREFERRED MODE FOR CARRYING OUT THE INVENTION

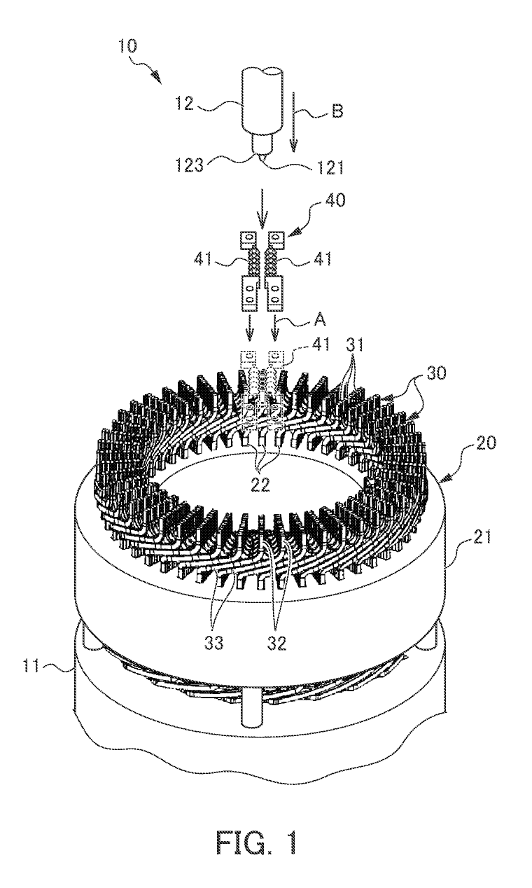

Hereinafter, an embodiment of the present invention will be described in detail with reference to accompanying drawings. A clamp jig 40 and a stator 20 that has a segment 30 welded by a welding device 10 as a stator manufacturing device will be described first. FIG. 1 is a schematic diagram illustrating how the stator 20 is manufactured by means of the welding device 10 as the stator manufacturing device according to an embodiment of the present invention.

The welding device 10 is provided with a stator jig 11, a welding torch 12, and the clamp jig 40. The stator jig 11 supports the stator 20 to be rotatable about the axis center of the stator 20. In this configuration, the stator 20 is rotated and the position of an end part 31 of the segment 30 inserted in the stator 20 with respect to the welding torch 12 can be changed by the stator jig 11 rotating.

The welding torch 12 is supported to be movable in the up-down direction and the radial direction of the stator 20. The welding torch 12 is provided with an electrode 121 of TIG welding and a shield gas outlet 123. In the present embodiment, TIG welding is used as a welding method. As described below, in a row of the end parts 31 of one segment 30, eight end parts 31 are welded two by two by TIG welding. Subsequently, the stator 20 is rotated by the stator jig 11 and eight end parts 31 in a row of the end parts 31 of another segment 30 adjacent to the row of the end parts 31 of the segment 30 are welded two by two by TIG welding. By this being repeated, in this configuration, the end parts 31 of a plurality of the segments 30 are electrically connected two by two.

The stator 20 is provided with a stator core 21, a plurality of slots 22, and the plurality of segments 30 as electric conductors. The stator core 21 has a cylindrical shape, and the plurality of slots 22 are formed in the stator core 21. Through holes penetrating the stator core 21 in the axis direction of the stator core 21 constitute the plurality of slots 22, and the plurality of slots 22 are formed radially about the axis center of the stator core 21 and over the entire circumferential direction.

The segment 30 has a conductor 32 to be energized and an insulating film 33 insulating the surroundings by covering the conductor 32. A rectangular wire rod made of copper constitutes the conductor 32. A soft insulating material constitutes the insulating film 33. For example, in the present embodiment, an enamel film covering the surface of the conductor 32 and a PEEK material film covering the outside of the enamel film constitute the insulating film 33. The insulating film 33 is peeled off and the rectangular wire rod is exposed at the end part 31 of the segment 31.

The plurality of segments 30 are respectively inserted in the plurality of slots 22 formed in the stator 20. By the segment 30 being put into a state where the segment 30 is inserted in the stator core 21, the end parts 31 of the plurality of segments 30 are arranged in a row, eight by eight, in the radial direction of the stator core 21. A plurality of the rows of the end parts 31 of the segments 30 arranged eight by eight are arranged radially about the axis center of the stator core 21.

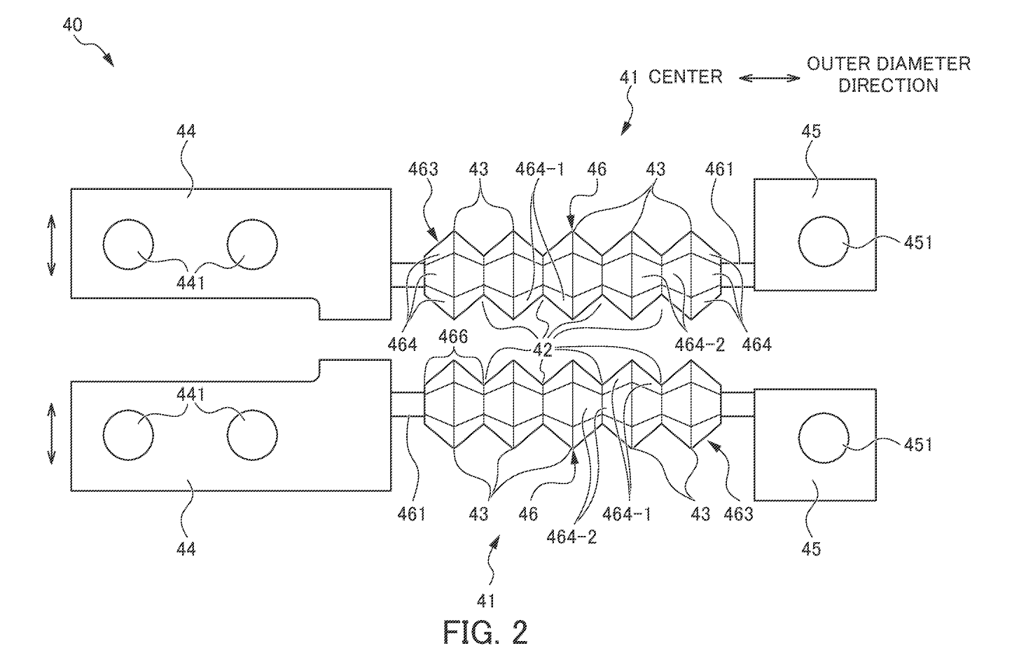

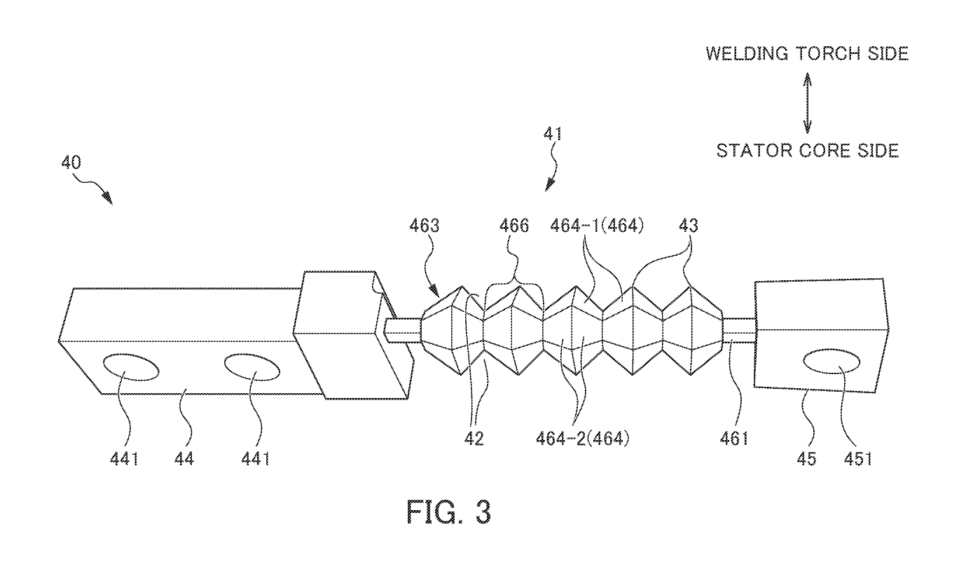

The clamp jig 40 will be described below. A pair of clamp bodies 41 constituting the clamp jig 40 has a bilaterally symmetrical shape, and thus only one of the clamp bodies 41 will be described below and description of the other will be omitted. FIG. 2 is a plan view illustrating the clamp jig 40 according to an embodiment of the present invention. FIG. 3 is a perspective view illustrating the clamp jig 40 according to an embodiment of the present invention.

The clamp jig 40 has the clamp body 41, and the clamp body 41 has a center side support part 44, an outer diameter side support part 45, and an intermediate sandwiched part 46. The center side support part 44, the intermediate sandwiched part 46, and the outer diameter side support part 45 have a positional relationship to be arranged in this order, are made of copper and connected by integral molding, and are used in a positional relationship in which the center side support part 44, the intermediate sandwiched part 46, and the outer diameter side support part 45 are extended in the radial direction of the stator core 21. The clamp jig 40 is supported by a moving device part (not illustrated) as moving means for allowing the clamp jig 40 to move relative to the stator core 21 in the axis direction of the stator core 21 (the direction indicated by the arrow A in FIG. 1 and the opposite direction thereto).

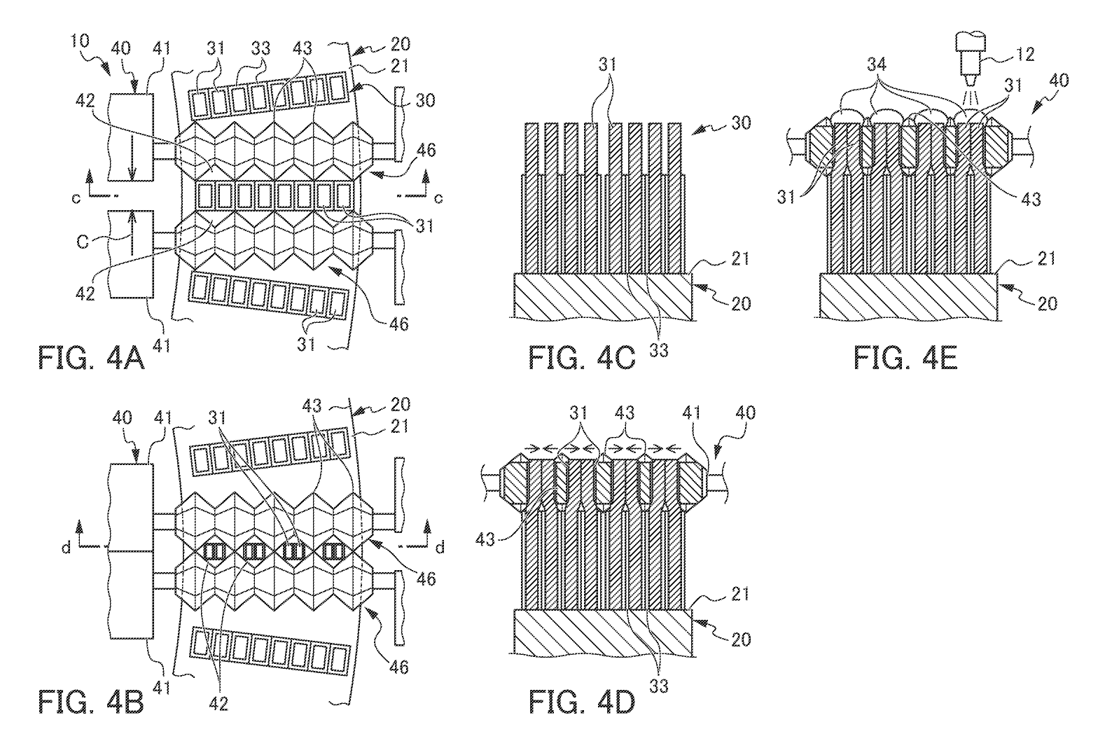

The center side support part 44 has a substantially rectangular parallelepiped shape, and two through holes 441 are formed along the longitudinal direction of the center side support part 44. The center side support part 44 is fixed to the moving device part (not illustrated) of the welding device 10 supporting the clamp jig 40 by a bolt (not illustrated) passing through each of the two through holes 441. The moving device part of the welding device 10 is provided with a clamp jig opening and closing device part (not illustrated) as clamp jig opening and closing means. The moving device part (not illustrated) is configured to open and close a pair of the clamp jigs 40 by causing the pair of clamp jigs 40 to be separated from each other or approach each other in the circumferential direction of the stator core 21 (substantially up-down direction in FIG. 4(a)) and for the end part 31 of the segment 30 inserted in the stator 20 to be clamped (sandwiched) by the clamp jigs 40 as a result.

The outer diameter side support part 45 has a substantially rectangular parallelepiped shape, and a through hole 451 is formed at a part close to the end part on the side that is opposite to the side connected to the intermediate sandwiched part 46. The outer diameter side support part 45 is fixed to the moving device part (not illustrated) of the welding device 10 supporting the clamp jig 40 by a bolt (not illustrated) passing through the through hole 451.

As illustrated in FIGS. 4(a) and 4(b), the intermediate sandwiched part 46 clamps the end part 31 of the segment 30 to be welded from both circumferential sides of the stator core 21 (substantially both upper and lower sides in FIG. 4(a)). As illustrated in FIG. 2 and so on, the intermediate sandwiched part 46 has a support shaft 461 and a sandwiched part 463.

As illustrated in FIG. 3 and so on, the support shaft 461 has a quadrangular prism shape. One end part and the other end part of the support shaft 461 are detachably inserted in quadrangular prism-shaped holes formed at the center side support part 44 and the outer diameter side support part 45, respectively. As a result, the support shaft 461 is non-rotatable with respect to the center side support part 44 and the outer diameter side support part 45.

The sandwiched part 463 is shaped by five parts 466 being integrally molded as one piece. At each of the five parts 466, the two bottom surfaces of two truncated pyramids are connected to each other. At the sandwiched part 463, the upper surfaces of the truncated pyramids are connected to each other. In other words, the sandwiched part 463 has a shape in which five beads of abacus are integrally connected. A quadrangular prism-shaped through hole (not illustrated) into which the support shaft 461 can be inserted is formed at the axial center position of the sandwiched part 463.

The part 466 that has the shape in which the bottom surfaces of two truncated pyramids are connected to each other has abutting surfaces 464, which are a plurality of side surfaces inclined with respect to the axis direction of the support shaft 461. The abutting surfaces 464 are arranged to radially spread about the support shaft 461 when seen in the axis direction of the support shaft 461, which leads to the bottom surface of the truncated pyramid from the upper surface of the truncated pyramid. A flat surface constitutes each of the abutting surfaces 464, and the abutting surface 464 abuts against the end part 31 of the segment 30 when the end part 31 of the segment 30 is clamped by the clamp jig 40. In this configuration, abutting surfaces 464-1 of the sandwiched parts 463 facing each other in the pair of clamp jigs 40 have a positional relationship not to face each other and abutting surfaces 464-2 of the sandwiched parts 463 facing each other in the pair of clamp jigs 40 have a positional relationship to face each other by the sandwiched part 463 being extracted from the support shaft 461 and the sandwiched part 463 being rotated about the axis center of the sandwiched part 463. The part of the sandwiched part 463 that protrudes in the direction orthogonal to the axis direction of the support shaft 461 constitutes a guide projection 43.

As illustrated in FIG. 2 and so on, five guide projections 43 protrude in the direction orthogonal to the axis direction of the support shaft 461. An end part accommodating recessed part 42 as a space between the guide projections 43 that are adjacent to each other in the axis direction of the support shaft 461 is formed at the intermediate sandwiched part 46 owing to the presence of the guide projection 43.

The end part accommodating recessed parts 42 are formed between those of the five guide projections 43 that are adjacent to each other, and a total of four end part accommodating recessed parts 42 are formed side by side in the radial direction of the stator core 21 (axis direction of the support shaft 461). A total of eight end parts 31 of the segment 30 are clamped by the clamp body 41 with two end parts 31 of the segment 30 accommodated at each of the four end part accommodating recessed parts 42.

A method for manufacturing a stator by using the welding device 10 that has the clamp jig 40 will be described below. FIG. 4 is a diagram illustrating how the stator 20 is manufactured by means of the stator manufacturing device 10 according to an embodiment of the present invention. FIG. 4(a) is a plan view illustrating a state where the end part 31 of the segment 30 is yet to be clamped by the clamp jig 40. FIG. 4(b) is a plan view illustrating a state where the segment end part 31 is clamped by the clamp jig 40. FIG. 4(c) is a sectional view taken along line c-c of FIG. 4(a). FIG. 4(d) is a sectional view taken along line d-d of FIG. 4(b). FIG. 4(e) is a sectional view illustrating how the segment end part 31 is welded.

Firstly, the stator 20 is rotated by the stator jig 11 being rotated and a row of the end parts 31 of the segment 30 to be clamped is moved to the vicinity of the clamp jig 40. Then, the clamp jig 40 is moved, by driving of the clamp moving device part, to a position where the intermediate sandwiched part 46 of the clamp jig 40 is capable of clamping the row of the end parts 31 of the segment 30 to be clamped. As illustrated in FIG. 4(a), the clamp bodies 41 are disposed between the row of the end parts 31 of the segment 30 to be clamped and the rows of the end parts 31 of the segments 30 next to the row on both sides among a plurality of the rows of the end parts 31 of the segments 30 formed in the circumferential direction of the stator core 21.

Next, the pair of clamp bodies 41 is allowed to approach each other in the direction indicated by the arrow C, as illustrated in FIG. 4(a), by the clamp jig opening and closing device part (not illustrated) of the welding device 10 being driven. As a result and as illustrated in FIGS. 4(b) and 4(d), eight end parts 31 of the segment 30 are clamped by the clamp body 41 in a state where two are accommodated per end part accommodating recessed part 42.

Next, the torch 12 is moved, in the direction indicated by the arrow B in FIG. 1, relative to the end parts 31 of the segment 30 clamped by the clamp bodies 41 and welding is performed, sequentially and two by two as illustrated in FIG. 4(e), on the four sets of the end parts 31 of the segment 30. As a result, a weld ball 34 is formed at the tip part of the end part 31 of the segment 30 and the end parts 31 of the segment 30 are welded two by two. All of the end parts 31 of the segment 30 are welded two by two by the above-described process being performed on each row of the eight end parts 31 of the segment 30 arranged in the radial direction of the stator core 21. As a result, the stator 20 is manufactured.

The following process is performed after the end part 31 of the segment 30 is clamped a predetermined number of times with the abutting surface 464-1 of the clamp jig 40 abutting against the end part 31 of the segment 30. Firstly, the support shaft 461 is removed from the outer diameter side support part 45 by one end part of the support shaft 461 being extracted from the hole at the outer diameter side support part 45. Next, the support shaft 461 is extracted from the sandwiched part 463, the support shaft 461 is rotated by 90° about the axis center of the sandwiched part 463, and then the support shaft 461 is inserted back into the sandwiched part 463. Then, one end part of the support shaft 461 is inserted back into the hole at the outer diameter side support part 45, and the support shaft 461 is non-rotatably fixed with respect to the outer diameter side support part 45. As a result, the other abutting surface 464-2 of the sandwiched part 463 abuts against the end part 31 of the segment 30 when the end part 31 of the segment 30 is clamped.

The present embodiment has the following effects. In the present embodiment, the clamp jig 40 has the pair of clamp bodies 41 that extends in the radial direction of the stator core 21 and that clamps, from both circumferential sides of the stator core 21, the end part 31 of the segment 30 as an electric conductor that is inserted into and welded to the stator core 21 and the sandwiched part 463 that abuts against the end part 31 of the segment 30 when the end part 31 of the segment 30 is clamped between the pair of clamp bodies 41. The sandwiched part 463 has the plurality of abutting surfaces 464 that can respectively abut against the end parts 31 of the segment 30 by the clamp jig 40 rotating.

In addition, in the present embodiment, the stator manufacturing device 10 manufacturing the stator 20 by welding the end part 31 of the segment 30 as an electric conductor inserted in the stator core 21 has the pair of clamp jigs 40 extended in the radial direction of the stator core 21 and clamping the end part 31 of the segment 30 to be welded from both sides in the circumferential direction of the stator core 21, the moving device part as moving means for allowing the stator core 21 and the clamp jig 40 to move relative to each other in the axis direction of the stator core 21, and the clamp jig opening and closing device part as clamp jig opening and closing means for opening and closing the pair of clamp jigs 40 by moving the pair of clamp jigs 40. The clamp jig 40 has the clamp body 41 and the sandwiched part 463 abutting against the end part 31 of the segment 30 when the end part 31 of the segment 30 is clamped between the pair of clamp bodies 41. The sandwiched part 463 has the plurality of abutting surfaces 464 that can respectively abut against the end parts 31 of the segment 30 by the clamp jig rotating.

As a result, abutting against the end part 31 of the segment 30 and clamping of the end part 31 of the segment 30 can be performed by means of the other abutting surface 464-2 of the sandwiched part 463 of the clamp jig 40 in the event of wear of the abutting surface 464-1 of the sandwiched part 463 of the clamp jig 40. Accordingly, the clamp jig 40 can be continuously used without replacement even in the event of wear of the abutting surface 464-1 of the sandwiched part 463 of the clamp jig 40, and thus the clamp jig 40 can be used for a long period of time.

The present invention is not limited to the above-described embodiment and includes, for example, any modification and improvement allowing the object of the present invention to be achieved. For example, the configuration of each part of the stator manufacturing device is not limited to the configuration of each part of the stator manufacturing device 10 according to the present embodiment. For example, the configuration of the sandwiched part 463 is not limited to the configuration of the sandwiched part 463 according to the present embodiment. For example, the shape of the support shaft 461 is not limited to a quadrangular prism shape and may also be, for example, a hexagonal column shape. In addition, the shape of the sandwiched part 463 is not limited to the shape in which the five beads of abacus are integrally connected.

In addition, although TIG welding is used as a welding method and the welding torch 12 is configured to be provided with the electrode of TIG welding and the shield gas outlet in the present embodiment, the present invention is not limited thereto. For example, MIG welding or the like may be used as an alternative welding method and any other welding method may be used insofar as the end part 31 of the segment 30 can be welded. In addition, the segment 30 may be inserted in an insulating insulator with the insulator inserted in the slot 22.

### EXPLANATION OF REFERENCE NUMERALS

10 WELDING DEVICE (STATOR MANUFACTURING DEVICE)
21 STATOR CORE
30 SEGMENT (ELECTRIC CONDUCTOR)
31 END PART
40 CLAMP JIG
41 CLAMP BODY
463 SANDWICHED PART
464 ABUTTING SURFACE

1. A clamp jig comprising:
a pair of clamp bodies that extends in the radial direction of a stator core and that clamps, from both circumferential sides of the stator core, an end part of an electric conductor that is inserted into and welded to the stator core; and
a sandwiched part that abuts against the end part of the electric conductor when the end part of the electric conductor is clamped between the pair of clamp bodies,
wherein the sandwiched part has a plurality of abutting surfaces that can respectively abut against the end parts of the electric conductor by the clamp jig rotating.

2. A stator manufacturing device manufacturing a stator by welding an end part of an electric conductor inserted in a stator core, the stator manufacturing device comprising:
a pair of clamp jigs that extends in the radial direction of the stator core and that clamps, from both circumferential sides of the stator core, an end part of an electric conductor to be welded;
moving means for allowing the stator core and the clamp jig to move relative to each other in the axis direction of the stator core; and
clamp jig opening and closing means for opening and closing the pair of clamp jigs by moving the pair of clamp jigs,
wherein the clamp jig includes a clamp body and a sandwiched part abutting against the end part of the electric conductor when the end part of the electric conductor is clamped between the pair of clamp bodies, and
wherein the sandwiched part has a plurality of abutting surfaces that can respectively abut against the end parts of the electric conductor by the clamp jig rotating.

3. A method for manufacturing a stator by using the clamp jig according to claim 1.

4. A method for manufacturing a stator by using the stator manufacturing device according to claim 2.
